(19) United States
(12) Patent Application Publication
(10) Pub. No.: US 2006/0014019 A1
(43) Pub. Date: Jan. 19, 2006

(54) Non-flak coated colouring pigment and method for the production and use thereof

(76) Inventors: Armin Kuebelbeck, Besnheim (DE); Jens Eichhorn, Reinheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/530,808

(22) PCT Filed: Sep. 23, 2003
(86) PCT No.: PCT/EP03/10552

§ 371 Date: Apr. 8, 2005

(30) Foreign Application Priority Data
Oct. 8, 2002 (EP) EP 02 022 553.8
Nov. 2, 2002 (EP) EP 02 024 370.5

(51) Int. Cl. B32B 7/02; B32B 17/02

(52) U.S. Cl. 428/403; 428/212

(57) ABSTRACT

The invention relates to a nonflake coated coloring pigment which consists of an inorganic or organic, amorphous or partially crystalline material and which is provided with at least one coating, where each layer comprises at least one cured melamine-formaldehyde resin or consists of one such resin. The pigment is particularly readily suitable for producing cosmetic products. It confers a pleasant skin sensation to the user of the cosmetic products.

The invention relates to a nonflake coated coloring pigment and to a method for the production and use thereof. The invention also relates to compositions which comprise such a pigment.

Cosmetic products often comprise pigments in order to give them a colored appearance. Some of these pigments convey to the user of the cosmetic products a harsh, dry and thus unpleasant sensation on the skin. This is the case particularly with pigments based on iron(III) hexacyanoferrate(II), which is also referred to as Prussian Blue, or chromium(III) oxide.

It is an object of the present invention to provide coloring pigments in particular for cosmetic products and other products which are applied to the skin which confer a pleasant sensation on the skin.

Surprisingly, it has been found that this object can be achieved by coating the coloring pigments with a cured melamine-formaldehyde resin.

Coated pigments are known in principle. Thus, EP-A-0 601 378 describes flake mica pigments coated with melamine resin. These pigments are used as effect pigments in metallic paints for automobiles, and the coating has the task of improving the storage stability of the paint and also the surface properties of the resulting paint film.

DE-A-197 10 619 discloses solids particles coated with melamine resin which are added to impregnating resin solutions for producing laminates in order to improve the abrasion resistance of the wooden materials coated with the laminates. The core of the coated solids particles consists of quartzes, nitrides, carbides. These are not coloring pigments.

The present invention provides a nonflake coated coloring pigment which is characterized in that the pigment consists of an inorganic or organic, amorphous or partially crystalline material which is provided with at least one coating, where each layer comprises at least one cured melamine-formaldehyde resin or consists of one such resin. Cosmetic products and other products which are applied to the skin confer to the user a pleasant sensation on the skin if they comprise a coloring pigment according to the invention.

The pigment is advantageously iron(III) hexacyanoferrate(II) or chromium(III) oxide. However, it is also possible to coat other pigments in the same way with a cured melamine-formaldehyde resin. These are, for example, titanium(IV) oxide, zirconium(IV) oxide, and oxides of iron, such as magnetite and hematite.

With the crosslinked melamine-formaldehyde resins, some of the melamine molecules can also be replaced by other crosslinkable molecules, such as, for example, phenols, guanamines or urea. The melamine-formaldehyde resins can be unetherified or etherified melamine-formaldehyde adducts, for example alkoxymethylol-melamines with C₁-C₆-alkoxy groups, such as methoxy or n-butoxy groups, and precondensates. By way of an example, an unetherified resin is Madurit MW 909, or an etherified resin is Madurit SMW 818 (both products from Solutia, Wiesbaden, Germany). Some of the melamine-formaldehyde resin can also be replaced by other crosslinking organic polymers. Of suitability here are in particular those which likewise have a high refractive index, very particularly those which have a refractive index which is greater than that of the uncoated pigment.

As a result of coating the pigment with melamine-formaldehyde without the addition of dye, the intrinsic color of the pigment also changes depending on the coating thickness. As the thickness of the coating increases, the color impression shifts in the direction of lighter and paler colors. At the coating thicknesses necessary for a more pleasant sensation on the skin, however, the effect of lightening is barely perceptible to the eye. The lightening naturally does not apply to colorless pigments, such as, for example, titanium(IV) oxide or zirconium(IV) oxide.

In contrast to flake pigments, upon coating with melamine-formaldehyde no interference color which can be adjusted through the coating thickness is formed. The reason for this is essentially the very uneven surface with nonflake pigments, which prevents a uniform layer thickness for forming an interference.

Any organic and inorganic dyes and also if appropriate colorless UV absorbers can be incorporated into the melamine-formaldehyde resins. A decisive factor for incorporation into the polymer matrix here is only its solubility in the medium in which the coating reaction is carried out. Even water-soluble dyes, such as, for example, eosine, fluoroscein or Victoria Pure Blue BO can be embedded into the polymer matrix without subsequently bleeding. In the case of lipophilic dyes, the coating reaction can likewise be carried out in an aqueous medium if the solubility promoters customary to the average skilled worker in the field are added. One example of a solubility promoter which may be mentioned here is 1-methyl-2-pyrrolidone.

In order to obtain color nuances it is possible to use the customary principles of additive color mixtures. Here, the color shades can be adjusted by mixing the dyes beforehand and introducing them together into a polymer layer, or by applying two or more dye-polymer layers to the inorganic substrate one after the other so that layers of different color are superimposed.

Acidochromic dyes, i.e. dyes whose color depends on the pH, can also essentially be incorporated into the melamine-formaldehyde resin while retaining the color shade and color change point. Examples which may be given here are phenolphthalein, bromothymol blue, bromoxylene blue and thymolphthalein.

Besides the fluoroscein already mentioned above, other fluorescent dyes, optical brighteners or other UV light-absorbing dyes can be incorporated into the polymer matrix.

In particular, it is advisable to incorporate two or more dyes, at least one dye of which is a fluorescent dye. It is particularly advantageous to incorporate at least two fluorescent dyes, the second fluorescent dye being added in considerably smaller amounts. As a result, pigments can be obtained whose resulting fluorescent color differs significantly from the fluorescent color of the starting materials. In this way, it is possible to synthesize a large number of differently fluorescent pigments in a simple way. By varying the type of the fluorescent dye or dyes and varying the second dye added in considerably smaller amounts, both with regard to the type and also the concentration, it is possible to produce a large bandwidth of fluorescent colors. Often, as a result of the low content of color-determining dyes, in visible light these pigments have a very inconspicuous and comparatively pale effect. Besides the base colors red, green and blue, well in excess of one hundred different fluorescent colors which can be clearly differentiated by eye can be realized.

By depositing a polymer layer comprising one or more fluorescent dyes onto a polymer layer which already comprises previously applied dye, it is possible to significantly increase the brilliance and luminance of the pigments. Moreover, bleaching of the underlying layers can be suppressed by the absorption of UV light. Such UV protection can also be achieved by incorporating UV absorbers into the dye-containing polymer layer itself.

In principle, suitable UV absorbers are all UV filters. Of particular preference are those UV filters whose physiological acceptability has been demonstrated. Both for UV-A filters and also for UV-B filters there are many tried and tested substances known from the specialist literature. Examples here are benzylidenecamphor derivatives, such as 3-(4′-methylbenzylidene)-dl-camphor, 3-benzylidenecamphor, polymers of N-{(2 and 4)-[(2-oxoborn-3-ylidene)methyl]benzyl}acrylamide, N,N,N-trimethyl-4-(2-oxoborn-3-ylidenemethyl)anilinium methylsulfate or α-(2-oxoborn-3-ylidene)toluene-4-sulfonic acid, benzoyl- or dibenzoylmethane, such as, for example, 1-(4-tert-butylphenyl)-3-(4-methoxyphenyl)propane-1,3-dione or 4-isopropyldibenzoylmethane, benzophenones, such as, for example, 2-hydroxy-4-methoxybenzophenone or 2-hydroxy-4-methoxybenzophenone-5-sulfonic acid and the sodium salt thereof, methoxycinnamic esters, such as, for example, octyl methoxycinnamate, isopentyl 4-methoxycinnamate and the isomer mixture thereof, salicylate derivatives, such as, for example, 2-ethylhexyl salicylate, 4-isopropylbenzyl salicylate or 3,3,5-trimethylcyclohexyl salicylate, 4-aminobenzoic acid and derivatives thereof, such as 2-ethylhexyl 4-(dimethylamino)benzoate or ethoxylated ethyl 4-aminobenzoate, and further substances, such as, for example, 2-ethylhexyl 2-cyano-3,3-diphenylacrylate, 2-phenylbenzimidazole-5-sulfonic acid, and the potassium, sodium and triethanolamine salts thereof, 3,3′-(1,4-phenylenedimethylene)bis(7,7-dimethyl-2-oxobicyclo[2.2.1]hept-1-ylmethanesulfonic acid and salts thereof and 2,4,6-trianilino(p-carbo-2′-ethylhexyl-1′-oxy)-1,3,5-triazine.

Further suitable organic UV filters are, for example, 2-(2H-benzotriazol-2-yl)-4-methyl-6-(2-methyl-3-(1,3,3,3-tetramethyl-1-(trimethylsilyloxy)disiloxanyl)-propyl)phenol, bis(2-ethylhexyl) 4,4′-[(6-[4-((1,1-di-methylethyl)aminocarbonyl)phenylamino]-1,3,5-triazine-2,4-diyl)diimino]bisbenzoate, α-(trimethylsilyl)-ω-[trimethylsilyl)oxy]poly[oxy(dimethyl[and about 6% methyl[2-[p-[2,2-bis(ethoxycarbonyl]vinyl]phenoxy]-1-methylenethyl] and about 1.5% methyl[3-[p-[2,2-bis-(ethoxycarbonyl)vinyl)phenoxy)propenyl) and 0.1 to 0.4% (methylhydrogen]silylene]] (n≈60) (CAS No. 207 574-74-1), 2,2′-methylenebis(6-(2H-benzotriazol-2-yl)-4-(1,1,3,3-tetramethylbutyl)phenol), 2,2′-(1,4-phenylene)bis(1H-benzimidazole-4,6-disulfonic acid, monosodium salt) and 2,4-bis{[4-(2-ethylhexyloxy)-2-hydroxy]phenyl}-6-(4-methoxyphenyl)-1,3,5-triazine.

Preferred compounds with UV-absorbing properties are 3-(4′-methylbenzylidene)-dl-camphor, 1-(4-tert-butylphenyl)-3-(4-methoxyphenyl)propane-1,3-dione, 4-isopropyldibenzoylmethane, 2-hydroxy-4-methoxybenzophenone, octyl methoxycinnamate, 3,3,5-trimethyl cyclohexylsalicylate, 2-ethylhexyl 4-(dimethylamino)-benzoate, 2-ethylhexyl 2-cyano-3,3-diphenylacrylate, 2-phenylbenzimidazole-5-sulfonic acid, and the potassium, sodium, and triethanolamine salts thereof.

By combining two or more UV filters, the protective effect against harmful influences of UV radiation can be optimized.

The coated coloring pigments can be produced by depositing crosslinking melamine-formaldehyde resins onto the suspended pigments and subsequently curing them, i.e. crosslinking the melamine-formaldehyde resins.

The method according to the invention for producing a coloring pigment with one or more coatings involves, in the case of a single coating,
a first step in which a coloring pigment is suspended in a basic aqueous medium comprising melamine and formaldehyde and/or methylolmelamine, which may optionally be alkoxylated, and
a second step in which crosslinking of the organic constituents is brought about by lowering the pH into the acidic range,
   and in the case of a multiple coating the first and second step is repeated with the product of the preceding coating operation.

It has been found that it is particularly advantageous to reduce the pH in the second process step by adding hydrogen peroxide, by oxidizing excess or unreacted formaldehyde from the first process step to give formic acid. Since formaldehyde is problematical in cosmetic applications, a pigment can thus be provided which is free from free formaldehyde molecules and thus cosmetically acceptable. This also functions with methylolmelamines since these in most cases also comprise sufficient amounts of free formaldehyde.

In the method according to the invention, some of the melamine can be replaced by other crosslinking molecules from the group consisting of “guanamines, phenols and ureas” and/or some of the methylolmelamine can be replaced by corresponding guanamine, phenol or urea analogs.

Inorganic or organic dyes and/or inorganic or organic UV absorbers can be added prior to the onset of the crosslinking reaction or during the crosslinking reaction.

Should the dyes or UV absorbers not completely dissolve in the aqueous medium, then complete dissolution can be brought about using solubility promoters. This applies particularly when using lipophilic substances.

The layer thickness of the coating can be controlled through the melamine-formaldehyde resin concentration. For example, at high concentrations, greater layer thicknesses are obtained than at low concentrations. The pH is also a suitable means for controlling the layer thickness. Low pH values lead to thinner coatings. DE 1595386 describes, moreover, the controlling of layer thicknesses through the addition of protective colloids.

Preferred overall layer thicknesses of substrates with one or more coatings are preferably 0.2 μm to 4 μm.

By using excess melamine-formaldehyde resin, additional and essentially round melamine-formaldehyde resin particles which, besides organic dyes, can also comprise UV absorbers or are entirely free from dyes or UV absorbers can be deposited onto the outermost coating.

Depending on the reaction procedure it is possible to control the number of spheres per coloring pigment particle, the sphere diameter, and the distribution of the sphere diameter (dispersity). For cosmetic purposes in particular, a certain content of spheres is advantageous for an improved sensation on the skin.

An excessively high content of spheres, however, reduces the brilliance and the appearance of the pigment. If the content of dye is sufficient, the additional spheres have a color which matches the coloring pigments.

The space-time yield relevant from the point of view of cost effectiveness can be significantly increased by adding polymers with strongly acidic groups, as is described, for example, in EP 0415273.

For certain applications it may be advantageous to also incorporate into the condensation product of the outermost layer of the polymer functional groups other than the specified strongly acidic groups in order to improve these, for example with regard to their binder compatibility and the dispersion behavior. Subsequently providing the outermost layer of the crosslinked organic polymer with functional groups by subsequent reaction of the melamine-formaldehyde resins is also possible. DD 224 602 describes various ways of functionalizing resins.

Functional groups for the purposes of this invention may be any hydrophilic or hydrophobic, acidic or basic groups, thus including, for example, even purely hydro-phobic largely inert groups, such as, for example, alcyl groups.

According to a method described in DD 224 602, the functional groups are incorporated into the surface of the polymer particles by carrying out the polycondensation reaction of the melamine-formaldehyde resin in the presence of amino functional compounds, where the amino functional compounds carry further functional groups besides the amino group. The amino functional compounds are added in amounts of from preferably 2 to 20 mol percent, based on the amount of methylolmelamine used, and incorporated into the melamine-formaldehyde network via the amino function. Thus, it is possible, for example when using amino acids, to incorporate carboxyl groups, or in the case of the sulfobetaines or aminophosphonic acids, to incorporate sulfo- or phosphonic acid groups into the surface of the particles. Such —COOH, —SO₃H and —PO₂H groups can in turn be reacted with other compounds. For example, the acid groups can be converted, by reaction with thionyl chloride, into corresponding acid chlorides which, for example, can in turn be reacted with alcohols or amines, forming the corresponding esters or amides. This method of surface modification is characterized by its simplicity since in an only slightly modified condensation process, functionalization of the melamine-formaldehyde resin surface takes place directly. However, disadvantageous effects which may arise are that, as a result of the condensation process, the corresponding functionalities are also incorporated in the polymer volume and thus the adhesion to the underlying layers or, in the case of a single-layer structure, the adhesion to the substrate, may be reduced. On the other hand, however, in the case of an appropriate selection for certain systems, the adhesion to the underlying layers or to the substrate can be increased if, as a result of the surface modification agent, groups are introduced which both improve the compatibility to the surrounding medium and also impart adhesion to the underlying layers or the substrate. In this method, however, as a result of the incorporation into the melamine-formaldehyde network, relatively large amounts of the surface-functionalizing agent are required. Also, more complex chemical functionalities through simple incorporation during polycondensation can be obtained only with difficulty.

Another method of surface functionalization starts therefore from an already polycondensed melamine-formaldehyde surface which has free, uncrosslinked methylolamine (NH—CH₂OH) or amino groups. These groups can, for example, be reacted with carbonoyl chlorides in a simple way. Thus, for example in the case of the use of long-chain carbonoyl chlorides, hydrophobicization of the pigment can be achieved. With perfluorinated acid chlorides, such as, for example, perfluorooctanoic acid, both hydrophobic and also lipophobic surfaces can be obtained. By using complex acid chlorides, which may comprise, for example, strongly UV light-absorbing groups, the melamine-formaldehyde surface can also contain further-reaching functionalities, e.g. a UV protection.

Advantageous embodiments of the invention arise from the dependent claims.

The invention also relates to compositions and cosmetic preparations which comprise one or more of the nonflake coated carrier materials as coloring pigment.

The nonflake coated coloring pigments according to the invention in the compositions or preparations can of course also be combined with any type of cosmetic raw materials and auxiliaries. These include, inter alia, oils, fats, waxes, film formers, preservatives and auxiliaries which generally determine application properties, such as, for example, thickeners and rheological additives, such as, for example, bentonites, hectorites, silicon dioxides, Ca silicates, gelatins, high molecular weight carbohydrates and/or surface-active auxiliaries, etc.

The formulations comprising the coloring pigments according to the invention can belong to the lipophilic, hydrophilic or hydrophobic type. In the case of heterogeneous formulations with discrete aqueous and nonaqueous phases, the coloring pigments according to the invention may in each case be present in only one of the two phases, or else be distributed over both phases.

The ph values of the formulations can be between 1 and 14, preferably between 2 and 11 and particularly preferably between 5 and 8.

The concentrations of the coloring pigments according to the invention in the formulation are not restricted. Depending on the application case, they can be between 0.001 (rinse-off products, e.g. shower gels) and 100% (e.g. shine-effect articles for particular applications).

Furthermore, the coloring pigments according to the invention can also be combined with cosmetic active ingredients. Suitable active ingredients are, for example, insect repellants, UV A/BC protective filters (e.g. OMC, B3, MBC), anti-aging active ingredients, vitamins and derivatives thereof (e.g. vitamin A, C, E, etc.), self-tanning agents (e.g. DHA, erytrolose, etc.) and further cosmetic active ingredients, such as, for example, bisabolol, LPO, ectoin, emblica, allantoin, bioflavanoids and derivatives thereof.

The preparations here are usually preparations which can be applied topically, for example cosmetic or dermatological formulations. In this case, the preparations comprise a cosmetically or dermatologically suitable carrier and optionally further suitable ingredients depending on the desired profile of properties.

As stated above, preparations which are particularly preferred according to the invention preferably comprise UV-B and UV-A-I filters. In principle, all UV filters are suitable for a combination with the coloring pigments according to the invention. Particular preference is given to those UV filters whose physiological acceptability has already been demonstrated. Both for UVA and also UVB filters there are many tried and tested substances known from the specialist literature, e.g.
benzylidinecamphor derivatives, such as 3-(4′-methyl-benzylidene)-dl-camphor (e.g. Eusolex® 6300), 3-benzylidenecamphor (e.g. Mexoryl® SD), polymers of N-{(2 and 4)-[(2-oxoborn-3-ylidene)methyl]benzyl}-acrylamide (e.g. Mexoryl® SW), N,N,N-trimethyl-4-(2-oxoborn-3-ylidenemethyl)anilinium methylsulfate (e.g. Mexoryl® SK) or (2-oxoborn-3-ylidene)toluene-4-sulfonic acid (e.g. Mexoryl® SL),
benzoyl or dibenzoylmethanes, such as 1-(4-tert-butyl-phenyl)-3-(4-methoxyphenyl)propane-1,3-dione (e.g. Eusolex® 9020) or 4-isopropyldibenzoylmethane (e.g. Eusolex® 8020),
benzophenones, such as 2-hydroxy-4-methoxybenzophenone (e.g. Eusolex® 4360) or 2-hydroxy-4-methoxybenzophenone-5-sulfonic acid and its sodium salt (e.g. Uvinul® MS-40),
methoxycinnamic esters, such as octyl methoxycinnamate (e.g. Eusolex® 2292), isopentyl 4-methoxycinnamate, e.g. as a mixture of the isomers (e.g. Neo Heliopan® E 1000),
salicylate derivatives, such as 2-ethylhexyl salicylate (e.g. Eusolex® OS), 4-isopropylbenzyl salicylate (e.g. Megasol®) or 3,3,5-trimethylcyclohexyl salicylate (e.g. Eusolex® HMS),
4-aminobenzoic acid and derivatives, such as 4-amino-benzoic acid, 2-ethylhexyl 4-(dimethylamino)benzoate (e.g. Eusolex® 6007), ethoxylated ethyl 4-aminobenzoate (e.g. Uvinul® P25),
phenylbenzimidazolesulfonic acids, such as 2-phenyl-benzimidazole-5-sulfonic acid, and its potassium, sodium and triethanolamine salts (e.g. Eusolex® 232), 2,2-(1,4-phenylene)bisbenzimidazole-4,6-disulfonic acid or salts thereof (e.g. Neoheliopan® AP) or 2,2-(1,4-phenylene)bisbenzimidazole-6-sulfonic acid;
   and further substances, such as
2-ethylhexyl 2-cyano-3,3-diphenylacrylate (e.g. Eusolex® OCR),
3,3′-(1,4-phenylenedimethylene)bis(7,7-dimethyl-2-oxobicyclo[2.2.1]hept-1-ylmethanesulfonic acid, and its salts (e.g. Mexoryl® SX) and
2,4,6-trianilino(p-carbo-2′-ethylhexyl-1′-oxy)-1,3,5-triazine (e.g. Uvinul® T 150)
hexyl 2-(4-diethylamino-2-hydroxybenzoyl)benzoate (e.g. Uvinul® UVA Plus, BASF).

The compounds given in the list should only be regarded as examples. It is of course also possible to use other UV filters.

These organic UV filters are generally incorporated into cosmetic formulations in an amount of from 0.5 to 10 percent by weight, preferably 1-8%.

Further suitable organic UV filters are, for example,
2-(2H-benzotriazol-2-yl)-4-methyl-6-(2-methyl-3-(1,3,3,3-tetramethyl-1-(trimethylsilyloxy)disiloxanyl)propyl)phenol (e.g. Silatrizole®),
bis(2-ethylhexyl) 4,4′-[(6-[4-((1,1-dimethyl-ethyl)aminocarbonyl)phenylamino]-1,3,5-triazine-2,4-diyl)diimino]bisbenzoate (e.g. Uvasorb® HEB),
α-(trimethylsilyl)-ω-[trimethylsilyl)oxy]poly[oxy-(dimethyl[and about 6% methyl[2-[p-[2,2-bis(ethoxycarbonyl]vinyl]phenoxy]-1-methylenethyl] and about 1.5% methyl[3-[p-[2,2-bis(ethoxy-carbonyl)vinyl)phenoxy)propenyl) and 0.1 to 0.4% (methylhydrogen]silylene]] (n≈60) (CAS No. 207 574-74-1),
2,2′-methylenebis(6-(2H-benzotriazol-2-yl)-4-(1,1,3,3-tetramethylbutyl)phenol) (CAS No. 103 597-45-1),
2,2′-(1,4-phenylene)bis(1H-benzimidazole-4,6-disulfonic acid, monosodium salt) (CAS no. 180 898-37-7) and
2,4-bis{[4-(2-ethylhexylbxy)-2-hydroxy]phenyl}-6-(4-methoxyphenyl)-1,3,5-triazine (CAS No. 103 597-45-, 187 393-00-6),
bis(2-ethylhexyl) 4,4′-[(6-[4-((1,1-dimethyl-ethyl)aminocarbonyl)phenylamino]-1,3,5-triazine-2,4-diyl)diimino]bisbenzoate (e.g. Uvasorb® HEB).

Organic UV filters are gene-rally incorporated into cosmetic formulations in an amount of from 0.5 to 20 percent by weight, preferably 1-15%.

Conceivable inorganic UV filters are those from the group of titanium dioxides, such as, for example, coated titanium dioxide (e.g. Eusolex® T-2000, Eusolex® T-AQUA), zinc oxides (e.g. Sachtotec®), iron oxides and also cerium oxides. These inorganic UV filters are generally incorporated into cosmetic preparations in an amount of from 0.5 to 20 percent by weight, preferably 2-10%.

Preferred compounds with UV-filtering properties are 3-(4′-methylbenzylidene)-dl-camphor, 1-(4-tert-butylphenyl)-3-(4-methoxyphenyl)propane-1,3-dione, 4-isopropyldibenzoylmethane, 2-hydroxy-4-methoxybenzophenone, octyl methoxycinnamate, 3,3,5-trimethylcyclohexyl salicylate, 2-ethylhexyl 4-(dimethylamino)-benzoate, 2-ethylhexyl 2-cyano-3,3-diphenylacrylate, 2-phenylbenzimidazole-5-sulfonic acid, and its potassium, sodium and triethanolamine salts.

Optimized compositions can comprise, for example, the combination of the organic UV filter 4′-methoxy-6-hydroxyflavone with 1-(4-tert-butylphenyl)-3-(4-methoxyphenyl)propane-1,3-dione and 3-(4′-methyl-benzylidene)-dl-camphor. This combination gives broadband protection, which can be further supplemented by adding inorganic UV filters, such as titanium dioxide microparticles.

All of the specified UV filters can also be used in encapsulated form. In particular, it is advantageous to use organic UV filters in encapsulated form. Specifically, the following advantages arise:
The hydrophilicity of the capsule wall can be adjusted irrespective of the solubility of the UV filter. Thus, for example, even hydrophobic UV filters can be incorporated into purely aqueous preparations. In addition, the oily impression upon applying the hydrophobic preparation comprising UV filters which is often regarded as being unpleasant is prevented.
Certain UV filters, in particular dibenzoylmethane derivatives, exhibit only reduced photostability in cosmetic preparations. By encapsulating these filters or compounds which impair the photo-stability of these filters, such as, for example, cinnamic acid derivatives, it is possible to increase the photostability of the overall preparation.
In the literature, the skin penetration by organic UV filters and the irritancy potential associated therewith upon direct application to the human skin is discussed time and again. By encapsulating the corresponding substances as proposed here, this effect is prevented.
In general, by encapsulating individual UV filters or other ingredients, preparation problems which arise as a result of individual preparation constituents interacting with one another, such as crystallization processes, precipitations and agglomeration, can be avoided since interaction is prevented.

Suitable capsules can have walls made of inorganic or organic polymers. For example, U.S. Pat. No. 6,242,099 B1 describes the production of suitable capsules with walls made of chitin, chitin derivatives or poly-hydroxylated polyamines. Capsules to be used particularly preferably according to the invention have walls which can be obtained by a sol-gel process as described in the applications WO 00/09652, WO 00/72806 and WO 00/71084. Preference is given here in turn to capsules whose walls are constructed from silica gel (silica; undefined silicon oxide hydroxide). The production of corresponding capsules is known to the person skilled in the art, for example from the cited patent applications, the contents of which expressly also belong to the subject-matter of the present application.

Here, the capsules are present in preparations according to the invention preferably in amounts which ensure that the encapsulated UV filters are present in the preparation in the amounts stated above.

A protective effect against oxidative stress and against the effect of free radicals can be achieved if the preparations comprise one or more antioxidants.

There are many tried and tested substances known from the specialist literature which can be used as anti-oxidants, e.g. amino acids (e.g. glycine, histidine, tyrosine, tryptophan) and derivatives thereof, imidazoles (e.g. urocanic acid) and derivatives thereof, peptides, such as D,L-carnosine, D-carnosine, L-carnosine and derivatives thereof (e.g. anserine), carotinoids, carotenes (e.g. α-carotene, β-carotene, lycopene) and derivatives thereof, chlorogenic acid and derivatives thereof, lipoic acid and derivatives thereof (e.g. dihydrolipoic acid), aurothioglucose, propylthiouracil and other thiols (e.g. thioredoxin, glutathione, cysteine, cystine, cystamine and the glycosyl, N-acetyl, methyl, ethyl, propyl, amyl, butyl and lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthionine sulfoximines, homocysteine sulfoximine, buthionine sulfones, penta-, hexa-, heptathionine sulfoximine) in very low tolerated doses (e.g. pmol to μmol/kg), and also (metal) chelating agents (e.g. α-hydroxy fatty acids, palmitic acid, phytic acid, lactoferrin), α-hydroxy acids (e.g. citric acid, lactic acid, malic acid), humic acid, bile acid, bile extract, bilirubin, biliverdin, EDTA, EGTA and derivatives thereof, unsaturated fatty acids and derivatives thereof, vitamin C and derivatives (e.g. ascorbyl palmitate, magnesium ascorbyl phosphate, ascorbyl acetate), tocopherols and derivatives (e.g. vitamin E acetate), vitamin A and derivatives (e.g. vitamin A palmitate), and coniferyl benzoate of benzoin resin, rutinic acid and derivatives thereof, α-glycosylrutin, ferulic acid, furfurylideneglucitol, carnosine, butylhydroxytoluene, butylhydroxyanisole, nordohydroguaiaretic acid, tri-hydroxybutyrophenone, quercitin, uric acid and derivatives thereof, mannose and derivatives thereof, zinc and derivatives thereof (e.g. ZnO, ZnSO₄), selenium and derivatives thereof (e.g. seleno-methionine), stilbenes and derivatives thereof (e.g. stilbene oxide, trans-stilbene oxide).

Mixtures of antioxidants are likewise suitable for use in the cosmetic preparations according to the invention. Known and commercial mixtures are, for example, mixtures comprising, as active ingredients, lecithin, L-(+)-ascorbyl palmitate and citric acid (e.g. Oxynex® AP), natural tocopherols, L-(+)-ascorbyl palmitate, L-(+)-ascorbic acid and citric acid (e.g. Oxynex® K LIQUID), tocopherol extracts from natural sources, L-(+)-ascorbyl palmitate, L-(+)-ascorbic acid and citric acid (e.g. Oxynex® L LIQUID), DL-α-tocopherol, L-(+)-ascorbyl palmitate, citric acid and lecithin (e.g. Oxynex® LM) or butylhydroxytoluene (BHT), L-(+)-ascorbyl palmitate and citric acid (e.g. Oxynex® 2004). Such antioxidants are used with the coloring pigments according to the invention in such compositions usually in ratios in the range from 1000:1 to 1:1000, preferably in amounts of from 100:1 to 1:100.

As further ingredients, the preparations according to the invention can comprise vitamins. Preferably, vitamins and vitamin derivatives chosen from vitamin A, vitamin A propionate, vitamin A palmitate, vitamin A acetate, retinol, vitamin B, thiamine chloride hydrochloride (vitamin B₁), riboflavin (vitamin B₂), nicotinamide, vitamin C (ascorbic acid), vitamin D, ergocalciferol (vitamin D₂), vitamin E, DL-α-tocopherol, tocopherol-E-acetate, tocopherol hydrogensuccinate, vitamin K₁, esculin (vitamin P active ingredient), thiamine (vitamin B₁), nicotinic acid (niacin), pyridoxine, pyridoxal, pyridoxamine, (vitamin B₆), pantothenic acid, biotin, folic acid and cobalamine (vitamin B₁₂) are present in the cosmetic preparations according to the invention, particularly preferably vitamin A palmitate, vitamin C, DL-α-tocopherol, tocopherol-E-acetate, nicotinic acid, pantothenic acid and biotin. Vitamins are used here with the coloring pigments according to the invention usually in ratios in the range from 1000:1 to 1:1000, preferably in amounts of from 100:1 to 1:100.

Moreover, the preparations according to the invention can comprise further customary skin-gentle or skincare active ingredients. These can in principle be all active ingredients known to the person skilled in the art.

Particularly preferred active ingredients are pyrimidinecarboxylic acids and/or aryl oximes.

Pyrimidinecarboxylic acids are present in halophilic microorganisms and play a role in the osmoregulation of these organisms (E. A. Galinski et al., Eur. J. Biochem., 149 (1985) pages 135-139). Here, among the pyrimidinecarboxylic acids, mention is made in particular of ectoin ((S)-1,4,5,6-tetrahydro-2-methyl-4-pyrimidinecarboxylic acid) and hydroxyectoin ((S,S)-1,4,5,6-tetrahydro-5-hydroxy-2-methyl-4-pyrimidine-carboxylic acid) and derivatives thereof. These compounds stabilize enzymes and other biomolecules in aqueous solutions and organic solvents. In addition, they stabilize enzymes in particular against denaturing conditions, such as salts, extreme pH values, surfactants, urea, guanidinium chloride and other compounds.

Ectoin and ectoin derivatives, such as hydroxyectoin, can advantageously be used in medicaments. In particular, hydroxyectoin can be used for producing a medicament for the treatment of skin disorders. Other fields of use of hydroxyectoin and other ectoin derivatives are typically in fields where, for example, trehalose is used as additive. Thus, ectoin derivatives, such as hydroxyectoin, can be used as protectant in dried yeast and bacteria cells. Pharmaceutical products, such as non-glycosylated pharmaceutically effective peptides and proteins, e.g. t-PA can also be protected with ectoin or its derivatives.

Among the cosmetic applications, the use of ectoin and ectoin derivatives for the care of aged, dry or irritated skin is mentioned in particular. Thus, European patent application EP-A-0 671 161 describes in particular that ectoin and hydroxyectoin are used in cosmetic preparations such as powders, soaps, surfactant-containing cleansing products, lipsticks, blusher, make-ups, care creams and sunscreen preparations.

Here, preference is given to using a pyrimidine-carboxylic acid according to formula I below, 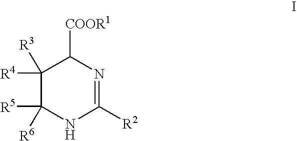
in which R¹ is a radical H or C1-8-alkyl, R² is a radical H or C₁₋₄-alkyl and R³, R⁴, R⁵ and R⁶, in each case independently of one another, are a radical from the group H, OH, NH₂ and C1-4-alkyl. Preference is given to using pyrimidinecarboxylic acids in which R² is a methyl or an ethyl group, and R¹ or R⁵ and R⁶ are H. Particular preference is given to using the pyrimidinecarboxylic acids ectoin ((S)-1,4,5,6-tetra-hydro-2-methyl-4-pyrimidinecarboxylic acid) and hydroxyectoin ((S,S)-1,4,5,6-tetrahydro-5-hydroxy-2-methyl-4-pyrimidinecarboxylic acid). Here, the preparations according to the invention comprise pyrimidinecarboxylic acids of this type preferably in amounts up to 15% by weight. Preferably, the pyrimidinecarboxylic acids are used here in ratios of from 100:1 to 1:100 relative to the coloring pigments according to the invention, particular preference being given to ratios in the range 1:10 to 10:1.

Among the aryl oximes, preference is given to using 2-hydroxy-5-methyllaurophenone oxime, which is also referred to as HMLO, LPO or F5. Its suitability for use in cosmetic compositions is known, for example, from the German laid-open specification DE-A-41 16 123. Preparations which comprise 2-hydroxy-5-methyllaurophenone oxime are accordingly suitable for treating skin disorders which involve inflammations. It is known that such preparations can be used, for example, for the treatment of psoriasis, various forms of eczema, irritative and toxic dermatitis, UV dermatitis and further allergic and/or inflammatory disorders of the skin and of the skin appendages. Preparations according to the invention which, besides the coloring pigments according to the invention, additionally comprise an aryl oxime, preferably 2-hydroxy-5-methyllaurophenone oxime, exhibit surprising anti-inflammatory suitability. Here, the preparations preferably comprise 0.01 to 10% by weight of the aryl oxime, it being particularly preferred for the preparation to comprise 0.05 to 5% by weight of aryl oxime.

All compounds or components which can be used in the preparations are either known or available commercially or can be synthesized by known methods.

The coloring pigments according to the invention can be incorporated into cosmetic preparations in the customary manner. Preparations for external application, for example in the form of cream, lotion, gel or solution which can be sprayed onto the skin are suitable. For internal application, administration forms such as capsules, sugar-coated tablets, powders, tablet solutions or solutions are suitable.

Examples of application forms of the compositions or preparations according to the invention which may be mentioned are: solutions, suspensions, emulsions, PIT emulsions, pastes, ointments, gels, creams, lotions, powders, soaps, surfactant-containing cleansing preparations, oils, aerosols and sprays. Further application forms are, for example, sticks, shampoos and shower baths. Any customary carrier substances, auxiliaries and optionally further active ingredients can be added to the preparation.

Preferred auxiliaries originate from the group of preservatives, antioxidants, stabilizers, solubility promoters, vitamins, colorants, odor improvers.

Ointments, pastes, creams and gels can comprise the customary carrier substances, e.g. animal and vegetable fats, waxes, paraffins, starch, tragacanth, cellulose derivatives, polyethylene glycols, silicones, bentonites, silica, talc and zinc oxide or mixtures of these substances.

Powders and sprays can comprise the customary carrier substances, e.g. milk sugar, talc, silica, aluminum hydroxide, calcium silicate and polyamide powder or mixtures of these substances. Sprays can additionally comprise the customary propellants, e.g. chlorofluorocarbons, propane/butane or dimethyl ether.

Solutions and emulsions can comprise the customary carrier substances, such as solvents, solubility promoters and emulsifiers, e.g. water, ethanol, isopropanol, ethyl carbonate, ethyl acetate, benzyl alcohol, benzyl benzoate, propylene glycol, 1,3-butyl glycol, oils, in particular cotton seed oil, peanut oil, corn oil, olive oil, castor oil and sesame oil, glycerol fatty acid esters, polyethylene glycols and fatty acid esters of sorbitan or mixtures of these substances.

Suspensions can comprise the customary carrier substances, such as liquid diluents, e.g. water, ethanol or propylene glycol, suspending agents, e.g. ethoxylated isostearyl alcohols, polyoxyethylene sorbitol esters and polyoxyethylene sorbitan esters, microcrystalline cellulose, aluminum metahydroxide, bentonite, agar agar and tragacanth or mixtures of these substances.

Soaps can comprise the customary carrier substances, such as alkali metal salts of fatty acids, salts of fatty acid half-esters, fatty acid protein hydrolysates, isothionates, lanolin, fatty alcohol, vegetable oils, plant extracts, glycerol, sugars or mixtures of these substances.

Surfactant-containing cleansing products can comprise the customary carrier substances, such as salts of fatty alcohol sulfates, fatty alcohol ether sulfates, sulfosuccinic half-esters, fatty acid protein hydrolysates, isothionates, imidazolinium derivatives, methyl taurates, sarcosinates, fatty acid amide ether sulfates, alkylamidobetaines, fatty alcohols, fatty acid glycerides, fatty acid diethanolamides, vegetable and synthetic oils, lanolin derivatives, ethoxylated glycerol fatty acid esters or mixtures of these substances.

Face and body oils can comprise the customary carrier substances such as synthetic oils, such as fatty acid esters, fatty alcohols, silicone oils, natural oils, such as vegetable oils and oily plant extracts, paraffin oils, lanolin oils or mixtures of these substances.

Further typical cosmetic application forms are also lipsticks, lipcare sticks, mascara, eyeliner, eye shadows, blusher, powder, emulsion and wax make-up, and sunscreen, presun and after-sun preparations.

Preferred preparation forms according to the invention include, in particular, emulsions.

Emulsions according to the invention are advantageous and comprise, for example, the specified fats, oils, waxes and other fatty substances, and also water and an emulsifier, as is customarily used for such a type of preparation.

The lipid phase can advantageously be chosen from the following group of substances:
mineral oils, mineral waxes
oils, such as triglycerides of capric acid or of caprylic acid, and also natural oils, such as, for example, castor oil;
fats, waxes and other natural and synthetic fatty substances, preferably esters of fatty acids with alcohols of low carbon number, e.g. with isopropanol, propylene glycol or glycerol, or esters of fatty alcohols with alkanoic acids of low carbon number or with fatty acids;
silicone oils, such as dimethylpolysiloxanes, diethylpolysiloxanes, diphenylpolysiloxanes, and mixed forms thereof.

The oil phase of the emulsions, oleogels and hydro-dispersions or lipodispersions for the purposes of the present invention is advantageously chosen from the group of esters of saturated and/or unsaturated, branched and/or unbranched alkanecarboxylic acids of chain length from 3 to 30 carbon atoms and saturated and/or unsaturated, branched and/or unbranched alcohols of chain length from 3 to 30 carbon atoms, from the group of esters of aromatic carboxylic acids and saturated and/or unsaturated, branched and/or unbranched alcohols of chain length from 3 to 30 carbon atoms. Such ester oils can then advantageously be chosen from the group consisting of isopropyl myristate, isopropyl palmitate, isopropyl stearate, isopropyl oleate, n-butyl stearate, n-hexyl laurate, n-decyl oleate, isooctyl stearate, isononyl stearate, isononyl isononanoate, 2-ethylhexyl palmitate, 2-ethylhexyl laurate, 2-hexaldecyl stearate, 2-octyldodecyl palmitate, oleyl oleate, oleyl erucate, erucyl oleate, erucyl erucate and synthetic, semisynthetic and natural mixtures of such esters, e.g. jojoba oil.

In addition, the oil phase can be chosen advantageously from the group of branched and unbranched hydrocarbons and hydrocarbon waxes, silicone oils, dialkyl ethers, the group of saturated or unsaturated, branched or unbranched alcohols, and fatty acid triglycerides, namely the triglyceryl esters of saturated and/or unsaturated, branched and/or unbranched alkane-carboxylic acids of chain length from 8 to 24, in particular 12-18, carbon atoms. The fatty acid triglycerides can, for example, be chosen advantageously from the group of synthetic, semi-synthetic and natural oils, e.g. olive oil, sunflower oil, soya oil, peanut oil, rapeseed oil, almond oil, palm oil, coconut oil, palm kernel oil and the like.

Any mixtures of such oil and wax components are also to be used advantageously for the purposes of the present invention. It may in some instances also be advantageous to use waxes, for example cetyl palmitate, as the sole lipid component of the oil phase.

Advantageously, the oil phase is chosen from the group consisting of 2-ethylhexyl isostearate, octyldodecanol, isotridecyl isononanoate, isoeicosane, 2-ethylhexyl cocoate, C₁₂₋₁₅-alkyl benzoate, caprylic-capric triglyceride, dicapryl ether.

Mixtures of C₁₂₋₁₅-alkyl benzoate and 2-ethylhexyl isostearate, mixtures of C₁₂₋₁₅-alkyl benzoate and isotridecyl isononanoate, and mixtures of C₁₂₋₁₅-alkyl benzoate, 2-ethylhexyl isostearate and isotridecyl isononanoate are particularly advantageous.

Of the hydrocarbons, paraffin oil, squalane and squalene are to be used advantageously for the purposes of the present invention.

Furthermore, the oil phase can also advantageously have a content of cyclic or linear silicone oils or consist entirely of such oils, although it is preferred to use an additional content of other oil phase components apart from the silicone oil or the silicone oils.

Cyclomethicone (octamethylcyclotetrasiloxane) is advantageously used as silicone oil to be used according to the invention. However, other silicone oils can also be used advantageously for the purposes of the present invention, for example hexamethylcyclo-trisiloxane, polydimethylsiloxane, poly(methylphenyl-siloxane).

Also particularly advantageous are mixtures of cyclo-methicone and isotridecyl isononanoate, and of cyclo-methicone and 2-ethylhexyl isostearate.

The aqueous phase of the preparations according to the invention optionally advantageously comprises alcohols, diols or polyols of low carbon number, and ethers thereof, preferably ethanol, isopropanol, propylene glycol, glycerol, ethylene glycol, ethylene glycol monoethyl or monobutyl ether, propylene glycol monomethyl, monoethyl or monobutyl ether, diethylene glycol monomethyl or monoethyl ether and analogous products, and also alcohols of low carbon number, e.g. ethanol, isopropanol, 1,2-propanediol, glycerol and in particular one or more thickeners, which can be chosen advantageously from the group consisting of silicon dioxide, aluminum silicates, polysaccharides and derivatives thereof, e.g. hyaluronic acid, xanthan gum, hydroxypropylmethylcellulose, particularly advantageously from the group of polyacrylates, preferably a polyacrylate from the group of so-called carbopols, for example carbopol grades 980, 981, 1382, 2984, 5984, in each case individually or in combination.

In particular, mixtures of the abovementioned solvents are used. In the case of alcoholic solvents, water may be a further constituent.

Emulsions according to the invention are advantageous and comprise, for example, the specified fats, oils, waxes and other fatty substances, and also water and an emulsifier, as is customarily used for such a type of formulation.

In a preferred embodiment, the preparations according to the invention comprise hydrophilic surfactants.

The hydrophilic surfactants are preferably chosen from the group of alkyl glucosides, acyl lactylates, betaines and cocoamphoacetates.

The alkyl glucosides are for their part advantageously chosen from the group of alkyl glucosides which are characterized by the structural formula 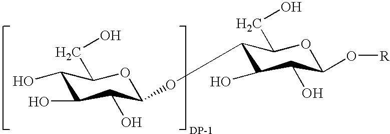
where R is a branched or unbranched alkyl radical having 4 to 24 carbon atoms and where \overline{DP} is an average degree of glucosylation of up to 2.

The value \overline{DP} represents the degree of glucosidation of the alkyl glucosides used according to the invention and is defined as

$$\overline{DP} = \frac{{p}_{1}}{100} \cdot 1 + \frac{{p}_{2}}{100} \cdot 2 + \frac{{p}_{3}}{100} \cdot 3 + … = Σ \frac{{p}_{i}}{100} \cdot i$$

Here, p₁, p₂, p₃ and pᵢ represent the fraction of the mono-, di-, tri- . . . i-fold glucosylated products in percentages by weight. According to the invention, products with degrees of glucosylation from 1-2 are chosen advantageously, particularly advantageously from 1.1 to 1.5, very particularly advantageously from 1.2-1.4, especially 1.3.

The value DP takes into account the fact that alkyl glucosides generally represent mixtures of mono- and oligoglucosides as a consequence of their preparation. According to the invention, a relatively high content of monoglucosides, typically in the order of magnitude of 40-70% by weight, is advantageous.

Alkyl glycosides used particularly advantageously according to the invention are chosen from the group consisting of octyl glucopyranoside, nonyl glucopyranoside, decyl glucopyranoside, undecyl glucopyranoside, dodecyl glucopyranoside, tetradecyl glucopyranoside and hexadecyl glucopyranoside.

It is likewise advantageous to use natural or synthetic raw materials and auxiliaries or mixtures which are characterized by an effective content of the active ingredients used according to the invention, for example Plantaren® 1200 (Henkel KGaA), Oramix® NS 10 (Seppic).

The acyl lactylates are for their part advantageously chosen from the group of substances which are characterized by the structural formula 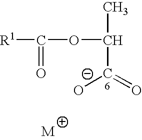
where R¹ is a branched or unbranched alkyl radical having 1 to 30 carbon atoms and M⁺ is chosen from the group of alkali metal ions and the group of ammonium ions substituted by one or more alkyl radicals and/or one or more hydroxyalkyl radicals, or corresponds to the half equivalent of an alkaline earth metal ion.

For example, sodium isostearyl lactylate, for example the product Pathionic® ISL from American Ingredients Company, is advantageous.

The betaines are advantageously chosen from the group of substances which are characterized by the structural formula 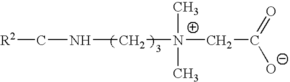
where R² is a branched or unbranched alkyl radical having 1 to 30 carbon atoms.

R² is particularly advantageously a branched or unbranched alkyl radical having 6 to 12 carbon atoms.

For example, capramidopropylbetaine, for example the product Tego® Betaine 810 from Th. Goldschmidt AG, is advantageous.

The cocoamphoacetate advantageous according to the invention chosen is, for example, sodium cocoampho-acetate, as is available under the name Miranol® Ultra C32 from Miranol Chemical Corp.

The preparations according to the invention are advantageously characterized in that the hydrophilic surfactant or surfactants is or are present in concentrations of 0.01-20% by weight, preferably 0.05-10% by weight, particularly preferably 0.1-5% by weight, in each case based on the total weight of the composition.

For use, the cosmetic and dermatological preparations according to the invention are applied to the skin and/or the hair in a sufficient amount in the manner customary for cosmetics.

Cosmetic and dermatological preparations according to the invention may be in various forms. Thus, for example, they may be a solution, an anhydrous preparation, an emulsion or microemulsion of the water-in-oil (W/O) type or of the oil-in-water (O/W) type, a multiple emulsion, for example of the water-in-oil-in-water (W/O/W) type, a gel, a solid stick, an ointment or else an aerosol. It is also advantageous to administer ectoins in encapsulated form, e.g. in collagen matrices and other customary encapsulation materials, e.g. as cellulose encapsulations, in gelatin, wax matrices or liposomally encapsulated. In particular, wax matrices as described in DE-A 43 08 282 have proven to be favorable. Preference is given to emulsions. O/W emulsions are particularly preferred. Emulsions, W/O emulsions and O/W emulsions are obtainable in the customary manner.

The emulsifiers used may be, for example, the known W/O and O/W emulsifiers. It is advantageous to use further customary coemulsifiers in the preferred O/W emulsions according to the invention.

According to the invention, the coemulsifiers chosen are advantageously, for example, O/W emulsifiers, primarily from the group of substances with HLB values of 11-16, very particularly advantageously with HLB values of 14.5-15.5, provided the O/W emulsifiers have saturated radicals R and R′. If the O/W emulsifiers have unsaturated radicals R and/or R′, or if isoalkyl derivatives are present, then the preferred HLB value of such emulsifiers may also be lower or higher.

It is advantageous to choose the fatty alcohol ethoxylates from the group of ethoxylated stearyl alcohols, cetyl alcohols, cetylstearyl alcohols (cetearyl alcohols). Particular preference is given to: polyethylene glycol(13) stearyl ether (steareth-13), polyethylene glycol(14) stearyl ether (steareth-14), polyethylene glycol(15) stearyl ether (steareth-15), polyethylene glycol(16) stearyl ether (steareth-16), polyethylene glycol(17) stearyl ether (steareth-17), polyethylene glycol(18) stearyl ether (steareth-18), polyethylene glycol(19) stearyl ether (steareth-19), polyethylene glycol(20) stearyl ether (steareth-20), polyethylene glycol(12) isostearyl ether (isosteareth-12), polyethylene glycol(13) isostearyl ether (isosteareth-13), polyethylene glycol(14) isostearyl ether (isosteareth-14), polyethylene glycol(15) isostearyl ether (isosteareth-15), polyethylene glycol(16) isostearyl ether (isosteareth-16), polyethylene glycol(17) isostearyl ether (isosteareth-17), polyethylene glycol(18) isostearyl ether (isosteareth-18), polyethylene glycol(19) isostearyl ether (isosteareth-19), polyethylene glycol(20) isostearyl ether (isosteareth-20), polyethylene glycol(13) cetyl ether (ceteth-13), polyethylene glycol(14) cetyl ether (ceteth-14), polyethylene glycol(15) cetyl ether (ceteth-15), polyethylene glycol(16) cetyl ether (ceteth-16), polyethylene glycol(17) cetyl ether (ceteth-17), polyethylene glycol(18) cetyl ether (ceteth-18), polyethylene glycol(19) cetyl ether (ceteth-19), polyethylene glycol(20) cetyl ether (ceteth-20), polyethylene glycol(13) isocetyl ether (isoceteth-13), polyethylene glycol(14) isocetyl ether (isoceteth-14), polyethylene glycol(15) isocetyl ether (isoceteth-15), polyethylene glycol(16) isocetyl ether (isoceteth-16), polyethylene glycol(17) isocetyl ether (isoceteth-17), polyethylene glycol(18) isocetyl ether (isoceteth-18), polyethylene glycol(19) isocetyl ether (isoceteth-19), polyethylene glycol(20) isocetyl ether (isoceteth-20), polyethylene glycol(12) oleyl ether (oleth-12), polyethylene glycol(13) oleyl ether (oleth-13), polyethylene glycol(14) oleyl ether (oleth-14), polyethylene glycol(15) oleyl ether (oleth-15), polyethylene glycol(12) lauryl ether (laureth-12), polyethylene glycol(12) isolauryl ether (isolaureth-12), polyethylene glycol(13) cetylstearyl ether (ceteareth-13), polyethylene glycol(14) cetylstearyl ether (ceteareth-14), polyethylene glycol(15) cetylstearyl ether (ceteareth-15), polyethylene glycol(16) cetylstearyl ether (ceteareth-16), polyethylene glycol(17) cetylstearyl ether (ceteareth-17), polyethylene glycol(18) cetylstearyl ether (ceteareth-18), polyethylene glycol(19) cetylstearyl ether (ceteareth-19), polyethylene glycol(20) cetylstearyl ether (ceteareth-20).

It is also advantageous to choose the fatty acid ethoxylates from the following group:

polyethylene glycol(20) stearate, polyethylene glycol(21) stearate, polyethylene glycol(22) stearate, polyethylene glycol(23) stearate, polyethylene glycol(24) stearate, polyethylene glycol(25) stearate, polyethylene glycol(12) isostearate, polyethylene glycol(13) isostearate, polyethylene glycol(14) isostearate, polyethylene glycol(15) isostearate, polyethylene glycol(16) isostearate, polyethylene glycol(17) isostearate, polyethylene glycol(18) isostearate, polyethylene glycol(19) isostearate, polyethylene glycol(20) isostearate, polyethylene glycol(21) isostearate, polyethylene glycol(22) isostearate, polyethylene glycol(23) isostearate, polyethylene glycol(24) isostearate, polyethylene glycol(25) isostearate, polyethylene glycol(12) oleate, polyethylene glycol(13) oleate, polyethylene glycol(14) oleate, polyethylene glycol(15) oleate, polyethylene glycol(16) oleate, polyethylene glycol(17) oleate, polyethylene glycol(18) oleate, polyethylene glycol(19) oleate, polyethylene glycol(20) oleate.

Sodium laureth-11 carboxylate can advantageously be used as ethoxylated alkyl ether carboxylic acid or salt thereof. As alkyl ether sulfate, sodium laureth-14 sulfate can be used advantageously. The ethoxylated cholesterol derivative used may advantageously be polyethylene glycol(30) cholesteryl ether. Polyethylene glycol(25) soyasterol has also proven useful. Ethoxylated triglycerides which can be used advantageously are the polyethylene glycol(60) evening primrose glycerides.

It is also advantageous to choose the polyethylene glycol glycerol fatty acid esters from the group consisting of polyethylene glycol(20) glyceryl laurate, polyethylene glycol(21) glyceryl laurate, polyethylene glycol(22) glyceryl laurate, polyethylene glycol(23) glyceryl laurate, polyethylene glycol(6) glyceryl caprate/caprinate, polyethylene glycol(20) glyceryl oleate, polyethylene glycol(20) glyceryl isostearate, polyethylene glycol(18) glyceryl oleate (cocoate.

It is likewise favorable to choose the sorbitan esters from the group consisting of polyethylene glycol(20) sorbitan monolaurate, polyethylene glycol(20) sorbitan monostearate, polyethylene glycol(20) sorbitan monoisostearate, polyethylene glycol(20) sorbitan monopalmitate, polyethylene glycol(20) sorbitan monooleate.

Optional, but according to the invention in some cases advantageous W/O emulsifiers which may be used are:

fatty alcohols having 8 to 30 carbon atoms, monoglycerol esters of saturated and/or unsaturated, branched and/or unbranched alkanecarboxylic acids of chain length from 8 to 24, in particular 12-18, carbon atoms, diglycerol esters of saturated and/or unsaturated, branched and/or unbranched alkane-carboxylic acids of chain length from 8 to 24, in particular 12-18, carbon atoms, monoglycerol ethers of saturated and/or unsaturated, branched and/or unbranched alcohols of chain length from 8 to 24, in particular 12-18, carbon atoms, diglycerol ethers of saturated and/or unsaturated, branched and/or unbranched alcohols of chain length from 8 to 24, in particular 12-18, carbon atoms, propylene glycol esters of saturated and/or unsaturated, branched and/or unbranched alkanecarboxylic acids of chain length from 8 to 24, in particular 12-18, carbon atoms, and sorbitan esters of saturated and/or unsaturated, branched and/or unbranched alkanecarboxylic acids of chain length from 8 to 24, in particular 12-18, carbon atoms.

Particularly advantageous W/O emulsifiers are glyceryl monostearate, glyceryl monoisostearate, glyceryl monomyristate, glyceryl monooleate, diglyceryl monostearate, diglyceryl monoisostearate, propylene glycol monostearate, propylene glycol monoisostearate, propylene glycol monocaprylate, propylene glycol monolaurate, sorbitan monoisostearate, sorbitan monolaurate, sorbitan monocaprylate, sorbitan monoisooleate, sucrose distearate, cetyl alcohol, stearyl alcohol, arachidyl alcohol, behenyl alcohol, isobehenyl alcohol, selachyl alcohol, chimyl alcohol, polyethylene glycol(2) stearyl ether (steareth-2), glyceryl monolaurate, glyceryl monocaprinate, glyceryl monocaprylate.

Preparations preferred according to the invention are particularly suitable for protecting human skin against aging processes and against oxidative stress, i.e. against damage by free radicals, as are produced, for example, by solar irradiation, heat and other influences. For this, they are in various administration forms customarily used for this application. Thus, they may in particular be in the form of a lotion or emulsion, such as cream or milk (O/W, W/O, O/W/O, W/O/W), in the form of oily-alcoholic, oily-aqueous or aqueous-alcoholic gels or solutions, in the form of solid sticks, or be formulated as aerosol.

The preparation can comprise cosmetic adjuvants which are used customarily in this type of preparation, such as, for example, thickeners, softening agents, moisturizers, surface-active agents, emulsifiers, preservatives, antifoams, perfumes, waxes, lanolin, propellants, dyes and/or pigments which color the composition itself or the skin, and other ingredients customarily used in cosmetics.

Dispersants and/or solubilizers which may be used are an oil, wax or other fatty substances, a lower mono-alcohol or a lower polyol or mixtures thereof. Particularly preferred monoalcohols or polyols include ethanol, isopropanol, propylene glycol, glycerol and sorbitol.

A preferred embodiment of the invention is an emulsion which is in the form of a protective cream or milk and, apart from the coloring pigments according to the invention, comprises for example, fatty alcohols, fatty acids, fatty acid esters, in particular triglycerides of fatty acids, lanolin, natural and synthetic oils or waxes and emulsifiers in the presence of water.

Further preferred embodiments are oily lotions based on natural or synthetic oils and waxes, lanolin, fatty acid esters, in particular triglycerides of fatty acids, or oily-alcoholic lotions based on a lower alcohol, such as ethanol, or a glycerol, such as propylene glycol, and/or a polyol, such as glycerol, and oils, waxes and fatty acid esters, such as triglycerides of fatty acids.

The preparation according to the invention can also be in the form of an alcoholic gel which comprises one or more lower alcohols or polyols, such as ethanol, propylene glycol or glycerol, and a thickener, such as siliceous earth. The oily-alcoholic gels also comprise natural or synthetic oil or wax.

The solid sticks consist of natural or synthetic waxes and oils, fatty alcohols, fatty acids, fatty acid esters, lanolin and other fatty substances.

If a preparation is formulated as an aerosol, the customary propellants, such as alkanes, fluoroalkanes and chlorofluoroalkanes, are generally used.

The cosmetic preparation can also be used to protect the hair against photochemical damage in order to prevent changes in color nuances, decoloring or damage of a mechanical nature. In this case, formulation is suitably in the form of a shampoo, lotion, gel or emulsion for rinsing out, the particular preparation being applied before or after shampooing, before or after coloring or bleaching or before or after the permanent wave. A preparation in the form of a lotion or gel for styling and treatment, in the form of a lotion or gel for brushing or arranging a water wave, in the form of a hair lacquer, permanent waving composition, coloring or bleaching hair composition can also be chosen.

Apart from the coloring pigments according to the invention, the preparation with photoprotective properties can comprise various adjuvants used in this type of composition, such as interface-active agents, thickeners, polymers, softening agents, preservatives, foam stabilizers, electrolytes, organic solvents, silicone derivatives, oils, waxes, antigrease agents, dyes and/or pigments which color the composition itself or the hair or other ingredients customarily used for haircare.

The present invention further provides a method for the production of a preparation which is characterized in that at least one coloring pigment according to the invention is mixed with a cosmetically or dermatologically suitable carrier. The preparations according to the invention can be produced here using techniques which are well known to the person skilled in the art.

The present invention will be illustrated by reference to the following example.

### EXAMPLE

In a 100 ml Erlenmeyer flask, 0.631 g of 2,4,6-tri-amino-2,4,6-triazine (=melamine) was dissolved in 50 ml of deionized water and 0.5 ml of tetramethylammonium hydroxide solution 2.5% strength at 70° C. with stirring, and 0.22 ml of formaldehyde solution 37% strength was added. The clear solution was stirred for 15 minutes in order to ensure the formation of the methylolmelamine. 2 g of Prussian Blue were then added to the solution. Immediately afterwards, 0.3 ml of H₂O₂ 30% strength was added to the now blue suspension to initiate the coating process (polycondensation). The pigment formed was washed by means of a centrifuge using water and acetone, dried and assessed. Compared with the untreated Prussian Blue, the material coated with melamine exhibits a significantly more pleasant “greasy-creamy” sensation on the skin.

1. A nonflake coated coloring pigment characterized in that the pigment consists of an inorganic or organic, amorphous or partially crystalline material which is provided with at least one coating, where each layer comprises at least one cured melamine-formaldehyde resin or consists of one such resin.

2. The coloring pigment as claimed in claim 1, characterized in that it consists of iron(III) hexacyanoferrate(II) or chromium(III) oxide.

3. The coloring pigment as claimed in claim 1, characterized in that the cured melamine-formaldehyde resin comprises one or more inorganic or organic dyes and/or one or more inorganic or organic UV absorbers, the dyes being soluble in the medium in which the pigment is coated.

4. The coloring pigment as claimed in claim 3, characterized in that the dye or the dyes are present in one or more inside layers comprising melamine-formaldehyde resin and the UV absorber or the UV absorbers are present in one or more outer layers comprising melamine-formaldehyde resin.

5. The coloring pigment as claimed in claim 1, characterized in that essentially round cured melamine-formaldehyde resin particles which comprise one or more dyes and/or one or more UV absorbers or else are free from dyes and/or UV absorbers are additionally applied to the outermost coating.

6. The coloring pigment as claimed in claim 1, characterized in that the cured melamine-formaldehyde resin of the outermost layer is modified with functional groups.

7. The coloring pigment as claimed in claim 6, characterized in that the functional groups which modify the outermost layer is introduced via an amino functional compound which has one or more further functional groups besides the amino group by this amino functional compound taking part in the polycondensation reaction between melamine and formaldehyde and is incorporated into the melamine-formaldehyde network via the amino function and where the functional groups thus applied to the surface are optionally further modified.

8. The coloring pigment as claimed in claim 6, characterized in that the cured melamine-formaldehyde resin of the outermost layer is modified via the methylolamine or amino groups present therein with compounds reactive to hydroxyl and/or amino groups, with functionalization of the surface.

9. The coloring pigment according to claim 3, where the dyes present are at least one fluorescent dye and one further optionally fluorescent dye in the melamine-formaldehyde resin, where the further dye is present in an amount which imparts essentially no color or fluorescence to the pigment when this dye is used on its own.

10. A method for the production of a nonflake coloring pigment with one or more coatings, characterized in that
in the case of a single coating
in a first step a coloring pigment is suspended in a basic aqueous medium comprising melamine and formaldehyde and/or methylolmelamine, which may optionally be alkoxylated, and
in a second step crosslinking of the organic constituents is brought about by lowering the pH into the acidic range,
and in the case of a multiple coating
the steps one and two are repeated with the product of the preceding coating reaction.

11. The method as claimed in claim 10, characterized in that some of the melamine is replaced by other crosslinking molecules from the group consisting of “guanamines, phenols and ureas” and/or some of the methylolmelamine is replaced by corresponding guanamine, phenol or urea analogs.

12. The method as claimed in claim 10, characterized in that inorganic or organic dyes and/or inorganic or organic UV absorbers are added prior to the onset of crosslinking or during crosslinking.

13. The method as claimed in claim 12, characterized in that the dyes added are at least one fluorescent dye and a further optionally fluorescent dye, where the further dye is added in an amount which imparts essentially no color or fluorescence to the pigment when this dye is added on its own.

14. The method as claimed in claim 10, characterized in that the reduction in the pH in the acidic range is brought about by oxidation of excess formaldehyde and/or unreacted formaldehyde and/or formaldehyde present in the methylolmelamines by means of hydrogen peroxide.

15. The method as claimed in claim 10, characterized in that, in the last coating step, besides melamine and formaldehyde and/or methylolmelamine, an amino functional compound which has one or more functional groups besides the amino group takes part in the polycondensation reaction, the amino functional compound being incorporated into the melamine-formaldehyde network via the amino function, and the functional groups thus applied to the surface optionally being further modified.

16. The method as claimed in claim 10, characterized in that the cured melamine-formaldehyde resin of the outermost layer is reacted via the methylolamine or amino groups present on its surface with compounds which have a group which is reactive to hydroxyl and/or amino groups, besides one or more further functional groups.

17. The use of one or more of the nonflake coated coloring pigments of claim 1 as effect pigments in cosmetic formulations and/or other products which are intended for application to the skin.

18. A composition comprising one or more of the nonflake coated carrier materials of claim 1 as coloring pigment.

19. The composition as claimed in claim 18 comprising one or more of the nonflake coated carrier materials of this invention as coloring pigment, characterized in that the composition is a cosmetic preparation.
